(19) United States
(12) Patent Application Publication
(10) Pub. No.: US 2020/0073375 A1
(43) Pub. Date: Mar. 5, 2020

(54) APPARATUS, METHOD, AND COMPUTER-READABLE, NON-TRANSITORY MEDIUM

(71) Applicant: FUJITSU LIMITED, Kawasaki-shi (JP)

(72) Inventor: Satoshi Amemiya, Atsugi (JP)

(73) Assignee: FUJITSU LIMITED, Kawasaki-shi (JP)

(21) Appl. No.: 16/551,790

(22) Filed: Aug. 27, 2019

(30) Foreign Application Priority Data
Sep. 4, 2018 (JP) 2018-165176

(51) Int. Cl. G05B 23/02; G06N 7/00; G06F 17/18; G06K 9/62; G06N 20/00

(52) U.S. Cl. CPC G05B 23/0243; G06N 7/005; G06N 20/00; G06K 9/6218; G06F 17/18

(57) ABSTRACT

A learning device includes: a memory; and a processor coupled to the memory and the processor configured to execute a process, the process comprising: generating a probability distribution with respect to each of devices, from first sensor data for learning obtained from a sensor provided in each of the devices; calculating a difference degree among each group of the probability distributions; generating a probability model by synthesizing a group of which the difference degree is less than a threshold into a single probability distribution, multiplying each coefficient with each of the probability distributions, and adding resulting probability distributions to each other; and generating a standard for abnormality determination from the probability model.

### CROSS-REFERENCE TO RELATED APPLICATION

This application is based upon and claims the benefit of priority of the prior Japanese Patent Application No. 2018-165176, filed on Sep. 4, 2018, the entire contents of which are incorporated herein by reference.

### FIELD

A certain aspect of embodiments described herein relates to a learning device, a determining device, a learning method, a determining method and a computer-readable non-transitory medium.

### BACKGROUND

There is disclosed a technology in which it is determined whether sensor data of each sensor provided in a device such as a work device is abnormal or not, with use of a standard for abnormality determination (for example, see Japanese Patent Application Publication No. 2011-164950).

### SUMMARY

According to an aspect of the present invention, there is provided an apparatus including: a memory; and a processor coupled to the memory and the processor configured to execute a process, the process comprising: generating a probability distribution with respect to each of devices, from first sensor data for learning obtained from a sensor provided in each of the devices; calculating a difference degree among each group of the probability distributions; generating a probability model by synthesizing a group of which the difference degree is less than a threshold into a single probability distribution, multiplying each coefficient with each of the probability distributions, and adding resulting probability distributions to each other; and generating a standard for abnormality determination from the probability model.

According to an aspect of the present invention, there is provided a method including: generating a probability distribution with respect to each of devices, from first sensor data for learning obtained from a sensor provided in each of the devices; calculating a difference degree among each group of the probability distributions; generating a probability model by synthesizing a group of which the difference degree is less than a threshold into a single probability distribution, multiplying each coefficient with each of the probability distributions, and adding resulting probability distributions to each other; and generating a standard for abnormality determination from the probability model.

According to an aspect of the present invention, there is provided a computer-readable, non-transitory medium storing a program that causes a computer to execute a process, the process including: generating a probability distribution with respect to each of devices, from first sensor data for learning obtained from a sensor provided in each of the devices; calculating a difference degree among each group of the probability distributions; generating a probability model by synthesizing a group of which the difference degree is less than a threshold into a single probability distribution, multiplying each coefficient with each of the probability distributions, and adding resulting probability distributions to each other; and generating a standard for abnormality determination from the probability model.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an overall structure of a work device in accordance with a first embodiment.

FIG. 2A illustrates generating of a model for abnormality determination;

FIG. 2B illustrates abnormality determination;

FIG. 3A to FIG. 3C illustrate a probability distribution of sensor data obtained from a device and a correlation structure;

FIG. 4 illustrates generating of a mixed model;

FIG. 5 illustrates generating of a mixed model;

FIG. 6 illustrates generating of a mixed model in accordance with an embodiment;

FIG. 7 illustrates a flowchart of a learning process executed by a learning device;

FIG. 8 illustrates a flowchart of a determining process executed by a determining device;

FIG. 9A illustrates a hardware structure of a learning device and a determining device; and

FIG. 9B illustrates a work system of a modified embodiment.

### DESCRIPTION OF EMBODIMENTS

It is possible to make a standard for abnormality determination on the basis of machine learning by using sensor data of each sensor as data for learning. However, there may be a difference between distributions of the sensor data of devices. Therefore, if a new device is used, determination accuracy may be reduced when the standard for abnormality determination learned with respect to an old device is applied to the new device.

A description will be given of embodiments on the basis of drawings.

### First Embodiment

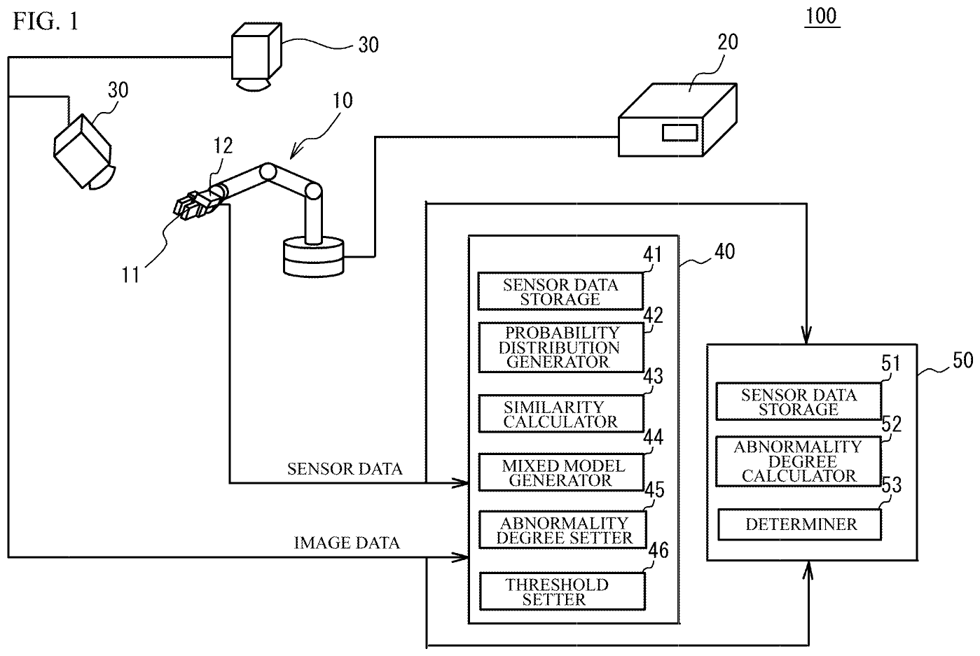

FIG. 1 illustrates an overall structure of a work device 100 in accordance with a first embodiment. As illustrated in FIG. 1, the work device 100 has a device 10, a controller 20, a camera 30, a learning device 40, a determining device 50 and so on.

The device 10 is a work robot used in a manufacturing line. The device 10 has a robot hand 11 and so on. The robot hand 11 is a device for performing a predetermined work with respect to an object. A sensor 12 is a sensor for detecting force of the robot hand 11, displacement of the robot hand 11, and so on. As an example, the sensor 12 is a strain gauge, a force sensor, an acceleration sensor or the like. In the embodiment, the number of the sensor 12 is two or more. Therefore, a plurality of sensing results (sensor data) are obtained. The controller 20 is a control device for instructing a work of the device 10 at a predetermined timing. The camera 30 is an imaging sensor for capturing an image of working of the device 10. Mainly, the camera 30 captures an image of an object (work or the like). The number of the camera 30 may be two or more.

The learning device 40 makes a standard for abnormality determination by making a probability distribution from sensor data for learning. The making of the standard for abnormality determination is roughly classified into estimation of statistic data model, setting of abnormality degree, and setting of a threshold for abnormality determination. The learning device 40 acts as a sensor data storage 41, a probability distribution generator, 42 a similarity calculator 43, a mixed model generator 44, an abnormality degree setter 45, a threshold setter 46 and so on.

The determining device 50 calculates abnormality degree on the basis of definition of set abnormality degree from a difference (divergence) between sensor data for determination and the standard for abnormality determination after reading the sensor data for determination. The determining device 50 determines whether abnormality occurs or not, with use of the threshold for determination. The determining device 50 acts as a sensor data storage 51, an abnormality degree calculator 52, a determiner 53 and so on.

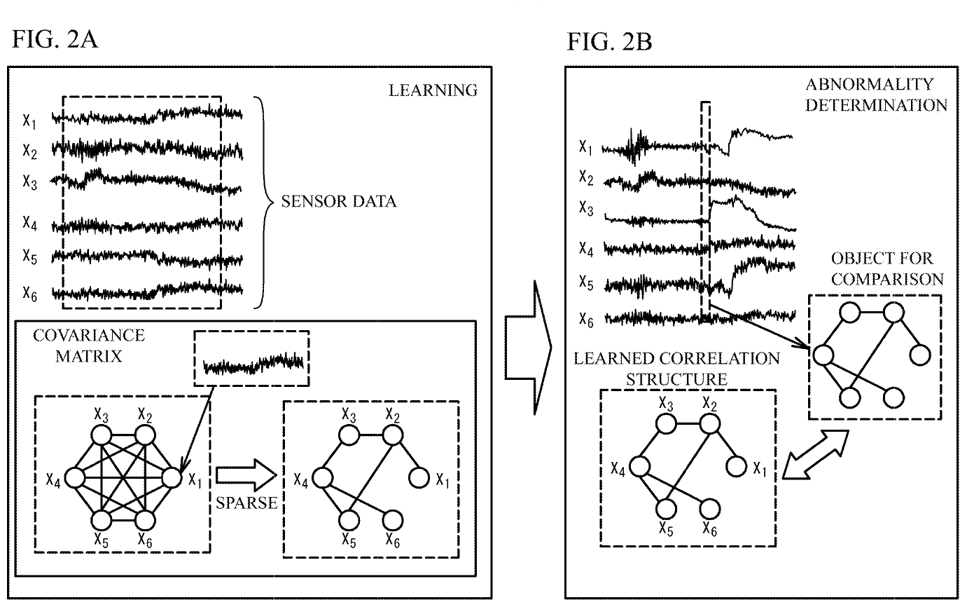

A description will be given of an example of generating (learning) of the standard for abnormality determination and abnormality determination. FIG. 2A illustrates generating of the standard for abnormality determination. In FIG. 2A, Gaussian Graphical Model (GM) is used. As illustrated in FIG. 2A, the sensor data for learning is obtained from the plurality of sensors. In an example of FIG. 2A, sensor data X₁ to X₆ are obtained from six sensors. A variance-covariance matrix Σ⁻¹ is calculated from the sensor data. Next, the variance-covariance matrix is converted into sparse by L1 regularization in accordance with the following formula (1). Conversion into sparse means that matrix elements which are not important are treated as zero. In the following formula (1), λ∥Σ⁻¹∥ a regularization term. By the conversion into sparse, a correlation structure among data of each sensor is obtained. The correlation structure can be used as a normal model of a case where abnormality does not occur. Therefore, it is possible to calculate the abnormality degree by calculating divergence of the sensor data from the correlation structure. “μ” means an average. “D” means the number of the sensor.

$$p ( x \vert μ , Σ ) = \frac{1}{{( 2 π )}^{D / 2}} \frac{1}{{\vert Σ \vert}^{2}} exp \{ - \frac{1}{2} {x}^{T} {Σ}^{- 1} x \} + λ ‖ {Σ}^{- 1} ‖ \qquad [ Formula 1 ]$$

FIG. 2B illustrates abnormality determination. As illustrated in FIG. 2B, the sensor data for determination are obtained from the plurality of sensors. A correlation structure for comparison is extracted from the sensor data for determination. The larger the difference between the extracted correlation structure and a correlation structure learned in advance is, the larger the abnormality degree (abnormality score) is. For example, the determining device 50 determines that abnormality occurs when an accumulated value of the abnormality score exceeds a threshold for abnormality determination.

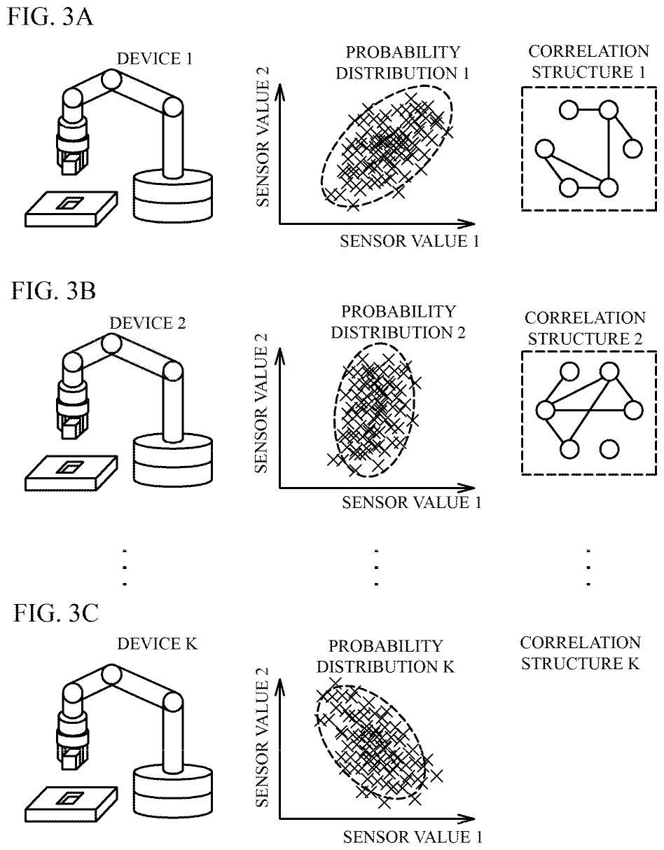

Here, probability distributions which are made from the sensor data for learning are described. FIG. 3A illustrates a probability distribution 1 of the sensor data obtained from a device 1. In FIG. 3A, the probability distribution 1 of a plurality of sensor values (a sensor value 1 and a sensor value 2) included in the sensor data is illustrated. And, a correlation structure 1 learned from the probability distribution 1 is illustrated. FIG. 3B illustrates a probability distribution 2 of the sensor data obtained from a device 2 and a correlation structure 2 learned from the probability distribution 2. FIG. 3C illustrates a probability distribution K of the sensor data obtained from the device K and a correlation structure K learned from the probability distribution K. The standard for abnormality determination is made from each of the correlation structures. The type of the devices is the same as each other. Each product number of the devices is different from each other. For example, the devices are work robots manufactured in accordance the same design or the same specification.

Each of the devices performs the same work. However, the devices are different from each other. Therefore, as illustrated in FIG. 3A to FIG. 3C, each different probability distribution of the devices is different from each other. And, each correlation structure of the devices is different from each other. Therefore, each standard for abnormality determination is made with respect to each device. However, for example, when a new device is used, it is preferable that the standard for abnormality determination learned with respect to an old device can be applied to the new device. For example, it is preferable that the standard for abnormality determination learned with respect to the device 1 can be applied to the device 2 and so on. However, even if the standard for abnormality determination made with respect to the device 1 is applied to the device 2, misdetection may occur because the probability distribution of the device 2 may be different from that of the device 1.

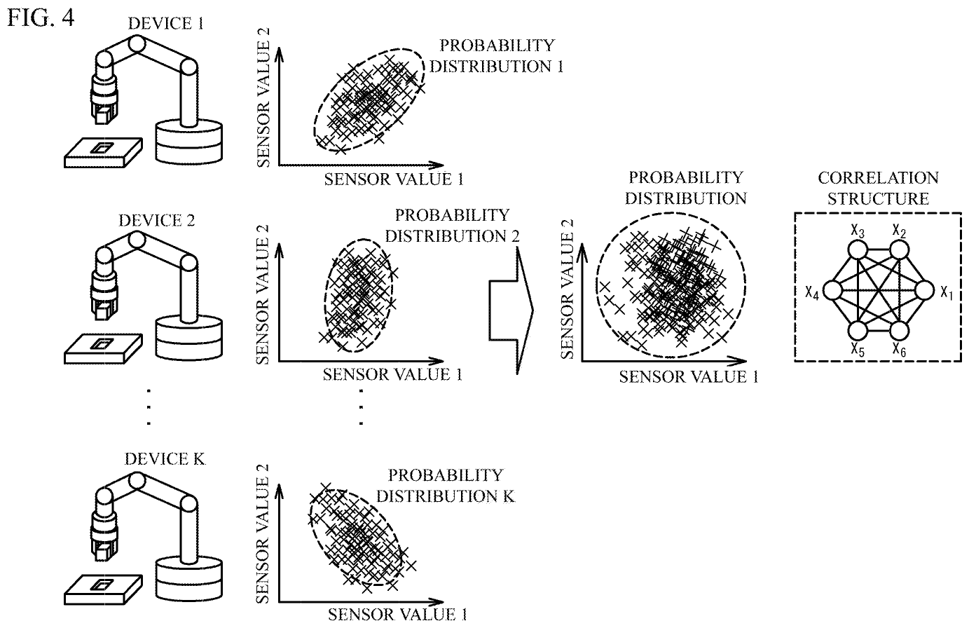

And so, as illustrated in FIG. 4, it is thought that all probability distributions (the probability distribution 1 to the probability distribution K) are added to each other, a correlation structure is learned from the resulting probability distribution, and a model (mixed model) for abnormality determination is made from the resulting correlation structure. However, in this case, the probability distribution is distributed in a wide range. Therefore, the probability distribution gets blurred. Thus, a feature of the correlation structure is not apparent. This results in reduction of accuracy of abnormality determination.

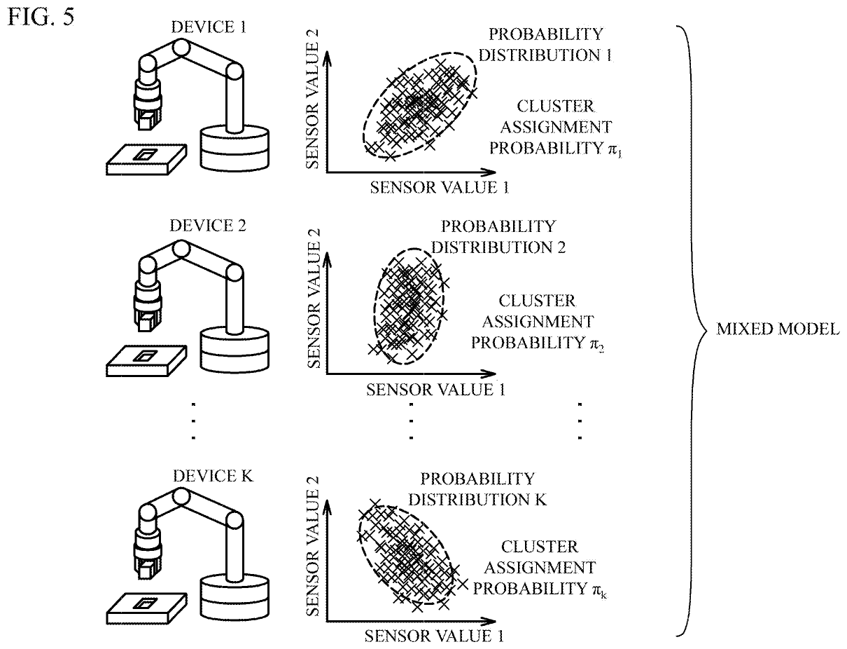

And so, as illustrated in FIG. 5, it is thought that each probability distribution is treated as a cluster, each cluster is multiplied with a cluster assignment probability as a coefficient, the resulting values are added to each other, and a mixed model is obtained. It is possible to express a probability distribution of a device i by the following formula (2). A ratio p(A) assigned in a cluster A in the whole of the population is a cluster assignment probability of the cluster A. In other words, the ratio may be called a mixed ratio.

p(x|μᵢ,Σᵢ) [Formula 2]

It is possible to express the cluster assignment probability of the probability distribution i by πᵢ. For example, the cluster assignment probability π₁ is multiplied with the probability distribution 1. A cluster assignment probability π₂ is multiplied with the probability distribution 2. It is possible to express the resulting probability distribution by the following formula (3). “θ” in the following formula (3) can be expressed by the following formula (4).

$$\begin{matrix}p ( x \vert Θ ) = {\sum }_{k = 1}^{K} {π}_{k} p ( x \vert {μ}_{k} , {Σ}_{k} ) & [ Formula 3 ] \\ Θ = \{ {π}_{1} , … {π}_{K} , {μ}_{1} , … {μ}_{K} , {Σ}_{1} , … {Σ}_{K} \} & [ Formula 4 ]\end{matrix}$$

In this case, it is possible to weight the probability distribution with the cluster assignment probability. Therefore, the reduction of the accuracy of abnormality determination is suppressed, compared to the case of FIG. 4. However, probability distributions of all devices are learned. In this case, learning cost may increase. And so, in order to reduce the learning cost, the number of the sensor data with respect to one cluster is reduced. In this case, the accuracy for abnormality determination may be degraded.

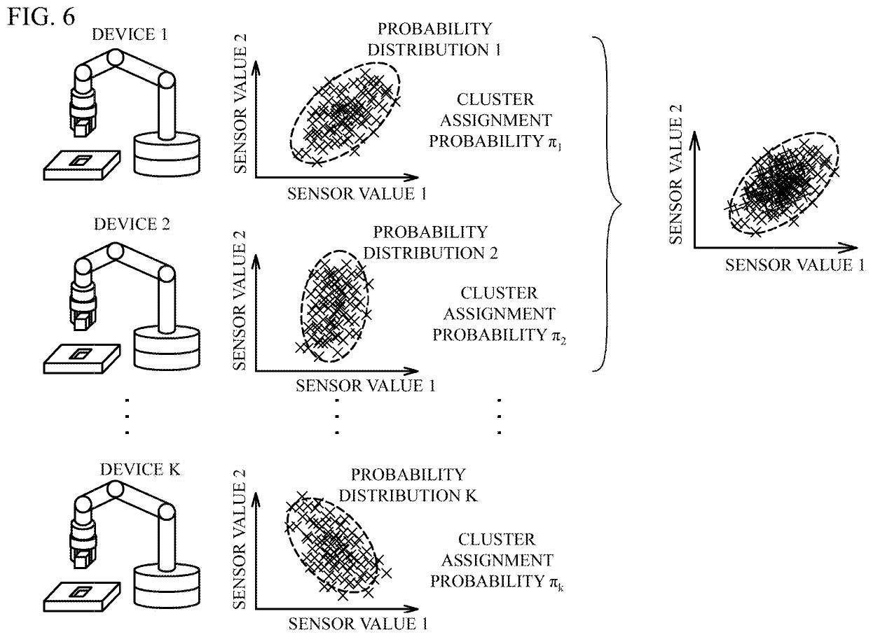

And so, in the embodiment, as illustrated in FIG. 6, a similarity degree between two probability distributions is calculated with used of an index indicating a difference degree of the two probability distributions such as KL divergence. It is possible to express the KL divergence by the following formula (5). When the KL divergence is small, the similarity degree between the two probability distributions is large. And so, when the KL divergence is less than a threshold c, the two probability distributions are synthesized into a single cluster and are treated as a single probability distribution. It is therefore possible to reduce the number of the cluster. For example, all two probability distributions of which the KL divergence is less than the threshold c are synthesized into a single cluster. In this case, the number of the cluster may be a minimum. It is possible to express the synthesized probability distribution by the following formula (6). It is possible to express the mixed model of which the number of the cluster is reduced, by the following formula (7).

$$\begin{matrix}KL ( p ( x \vert {μ}_{1} , {Σ}_{1} ) \vert \vert p ( x \vert {μ}_{2} , {Σ}_{2} ) ] & [ Formula 5 ] \\ p ( x \vert , ) & [ Formula 6 ] \\ p ( x \vert Θ ) = {\sum }_{k = 1}^{L} {π}_{k} p ( x \vert {μ}_{k} , {Σ}_{k} ) \\ \{ \begin{matrix}Θ = \{ {π}_{1} , … {π}_{L} , {μ}_{1} , … {μ}_{L} , {Σ}_{1} , … {Σ}_{L} \} \\ L < K\end{matrix} & [ Formula 7 ]\end{matrix}$$

Here, a method for determining the threshold c is described. For example, the threshold c of the difference degree is estimated when an observation model p(x|λ) with respect the difference degree (KL divergence) is assumed, a predicted distribution of the difference degree is estimated by Bayesian approach. The KL divergence expressed by the following formula (8) is a positive value. And so, the predicted distribution is calculated when an exponential distribution Expo is used as the observation model, and a gamma distribution (Gam) is used as a prior distribution. It is possible to express the observation model by the following formula (9). It is possible to express the prior distribution by the following formula (10). “a” and “b” indicate a hyper parameter for determining a distribution shape of the gamma distribution. Here, it is possible to define the probability distribution as the following formula (11). Γ(·) is a gamma function.

$$\begin{matrix}x ∈ X & [ Formula 8 ] \\ p ( x \vert λ ) = Expo ( x \vert λ ) & [ Formula 9 ] \\ p ( λ ) = Gam ( λ \vert a , b ) & [ Formula 10 ] \\ Gam ( λ \vert a , b ) = \frac{{b}^{a}}{Γ ( a )} {λ}^{a - 1} {e}^{- b λ} & [ Formula 11 ]\end{matrix}$$

It is possible to express the posterior distribution by the following formula 12).

$$p ( λ \vert X ) = Gam ( λ \vert \hat{a} , \hat{b} ) \\ \{ \begin{matrix}\hat{a} = \sum {x}_{n} + a \\ \hat{b} = N + b\end{matrix} \qquad [ Formula 12 ]$$

It is possible to express the KL divergence by the following formula (13), from the posterior distribution and the observation model.

$$P ( x \vert \hat{a} , \hat{b} ) = \int Expo ( x \vert λ ) Gam ( λ \vert \hat{a} , \hat{b} ) d λ ∝ \frac{\hat{a}}{\hat{b}} {( 1 + \frac{x}{\hat{b}} )}^{- ( 1 + \hat{a} )} = Par II ( x \vert \hat{a} , \hat{b} ) \qquad [ Formula 13 ]$$

It is possible to determine the threshold c, when a statistic amount (for example, a standard deviation, an average, a median or the like) of the following formula (14) is determined as the threshold c of the difference degree. “Par II” is a class 2 Pareto distribution.

ParII(x|â,\hat{b}) [Formula 14]

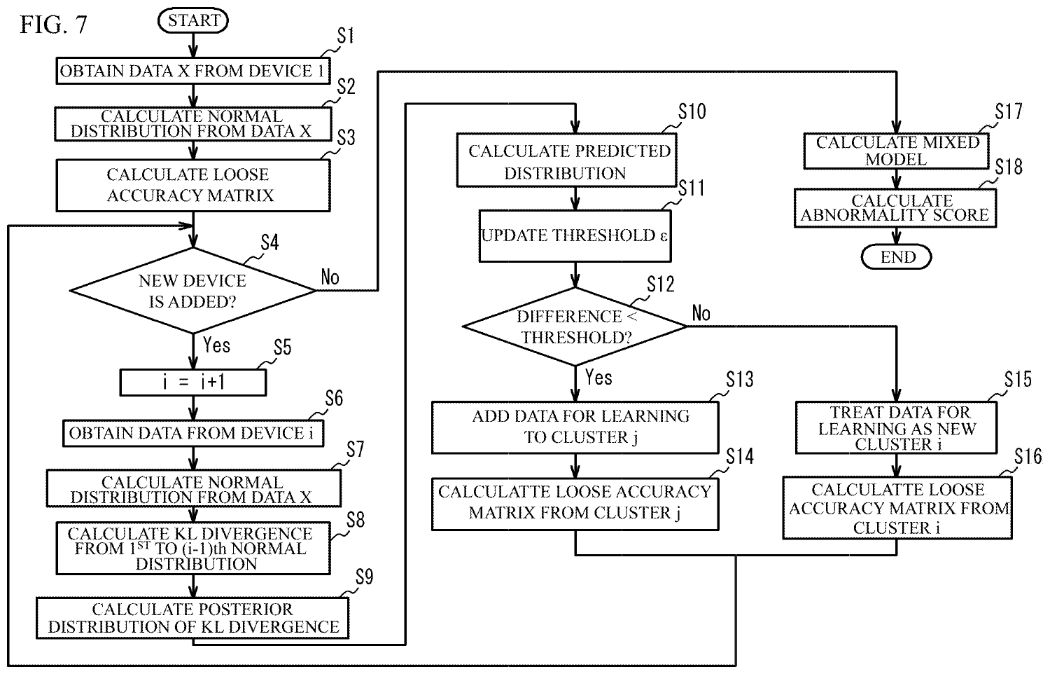

(Learning Process) FIG. 7 illustrates a flowchart of a learning process executed by the learning device 40. As illustrated in FIG. 7, the probability distribution generator 42 reads the sensor data X₁ for learning of the device 1, from the sensor data storage 41 (Step S1). The sensor data Xᵢ for learning includes {Xᵢ₁ to X_{iM}}. “i” indicates a device number. “M” indicates the number of data. “x₁ⱼ” indicates a D-dimensional vector. “D” indicates the number of the sensor.

Next, the probability distribution generator 42 calculates a normal distribution as a probability distribution expressed by the following formula (15), from the sensor data X₁ for learning (Step S2).

p(x|μ₁,Σ₁) [Formula 15]

Next, the probability distribution generator 42 uses the L1 regularization term calculated in Step S2 and calculates a loose accuracy matrix expressed by the following formula (16) (Step S3).

\tilde{Λ}₁ [Formula 16]

Next, the probability distribution generator 42 determines whether an additional learning is performed with respect to a new device (Step S4). When sensor data for learning of a new device which is not learned is accumulated, it is determined as “Yes” in Step S4. When it is determined as “Yes” in Step S4, the device number i is increased by 1 by calculating i=i+1 (Step S5).

Next, the probability distribution generator 42 reads sensor data Xᵢ for learning of a device i from the sensor data storage 41 (Step S6). Next, the probability distribution generator 42 calculates a normal distribution expressed by the following formula (17) as a probability distribution from the sensor data Xᵢ for learning (Step S7).

p(x|μᵢ,Σᵢ) [Formula 17]

Next, the similarity calculator 43 calculates each KL divergence between the normal distribution calculated in Step S7 and each of the normal distributions from the first to the (i−1)-th (the following formula (18) (Step S8).

p(x|μᵢ,Σᵢ) [Formula 18]

Next, the similarity calculator 43 calculates the posterior distribution of the KL divergence expressed by the following formula (19) (Step S9).

p(λ|Y)=Gam(λ|â,\hat{b}) [Formula 19]

Next, the similarity calculator 43 calculates a predicted distribution of the KL divergence expressed by the following formula (20) (Step S10). Here, a value yᵢ of the KL divergence is a scholar. Y={yᵢ to y₁} is a vector.

p(y|Y)=ParII(y|â,\hat{b}) [Formula 20]

Next, the similarity calculator 43 updates the threshold c, on the basis of the predicted distribution calculated in Step S10 (Step S11). Next, the similarity calculator 43 determines whether the following formula (21) is satisfied or not (Step S12).

$$\begin{matrix}∀ j \neq i , \\ KL [ p ( x \vert {μ}_{j \neq i} , {Σ}_{j \neq i} ) ‖ p ( x \vert {μ}_{i} , {Σ}_{i} ) ] > ɛ ?\end{matrix} \qquad [ Formula 21 ]$$

When it is determined as “Yes” in Step S12, the mixed model generator 44 adds the sensor data Xᵢ for learning to the cluster j (Step S13). Overlapping is allowed. Next, the mixed model generator 44 calculates a loose accuracy matrix expressed by the following formula (22) from the cluster j to which the sensor data for learning is added (Step S14). After that, Step S4 is executed again.

\tilde{Λ}ⱼ [Formula 22]

When it is determined as “No” in Step S12, the mixed model generator 44 uses the sensor data Xᵢ for learning as a new cluster i (Step S15). Next, the mixed model generator 44 calculates a loose accuracy matrix expressed by the following formula (23) from the new cluster i (Step S16). After that, Step S4 is executed again.

\tilde{Λ}ᵢ [Formula 23]

When it is determined as “No” in Step S4, all clusters have been made. And so, the mixed model generator 44 calculates a mixed model (probability model) expressed by the following formula (24) Step S17). Next, the abnormality degree setter 45 sets the abnormality degree. The abnormality degree is a parameter which gets larger when the divergence between the mixed model and the sensor data gets larger. The threshold setter 46 calculates an abnormality score a(x)=1np(x|θ) on the basis of the definition (Step S18). It is possible to use the abnormality score a(x) as the threshold for abnormality determination. With the processes, the flowchart is terminated.

$$p ( x \vert θ ) = {\sum }_{k = 1}^{L} {π}_{k} p ( x \vert {μ}_{k} , {k}_{} ) \qquad [ Formula 24 ]$$

In the embodiment, each probability distribution is made with respect to each of the devices 10, from the sensor data for learning obtained from the sensor 12 provided in each of the devices 10. Next, a difference degree among each group of the probability distributions is calculated. The probability distributions of which difference degree is less than the threshold are synthesized into a single probability distribution. Each coefficient is multiplexed with each of the probability distributions. After that, the probability distributions are added to each other. Thus, a mixed model (probability model) is generated. The standard for abnormality determination (the threshold for abnormality determination) is made from the probability model. With the structure, the degradation of the determination accuracy is suppressed when a new device is used. It is possible to reduce the number of the cluster when generating the mixed model. It is therefore possible to reduce the cost. When the number of the cluster is reduced, it is not necessary to reduce the number of the sensor data with respect to one cluster. Therefore, the determination accuracy is improved.

When the KL divergence is used, it is possible to calculate the difference degree between the probability distributions. It is possible to calculate the threshold of high accuracy, when an observation model of the difference degree is assumed, a distribution of the difference degree is predicted by Bayesian approach, and a statistic amount of the distribution is used as a value.

In the above-mentioned embodiment, the KL divergence is used as an example of indices for indicating the similarity degree. However, the index is not limited to the KL divergence. For example, JS (Jensen Shannon) divergence, Histgram Intersection, Lp norm (p is a positive integer), L0 norm or the like may be used as the index.

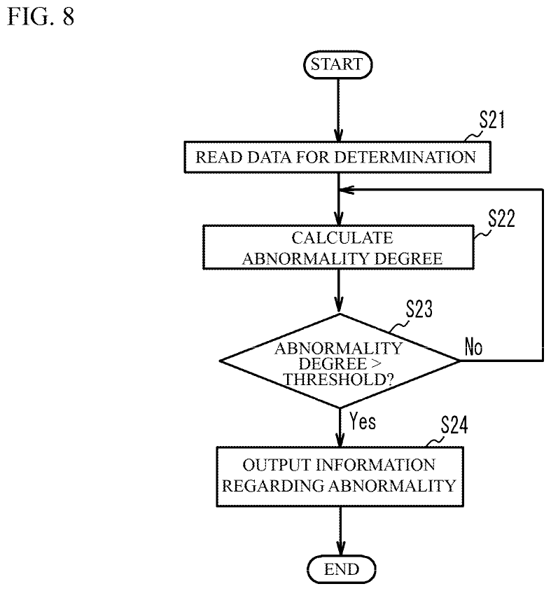

(Determining Process) FIG. 8 illustrates a flowchart of a determining process executed by the determining device 50. As illustrated in FIG. 8, the abnormality degree calculator 52 obtains the sensor data for determining stored in the sensor data storage 51 (Step S21). Next, the determiner 53 calculates the abnormality degree with use of the model for abnormality determination obtained by the learning process (Step S22).

The determiner 53 determines whether the accumulated value of the abnormality degree exceeds a threshold (Step S23). When it is determined as “No” in Step S23, Step S22 is executed again. When it is determined as “Yes” in Step S23, the determiner 53 outputs information regarding abnormality (Step S24).

In the embodiment, the determination accuracy with respect to the sensor data for determining is improved when the threshold for abnormality determination obtained in the learning process is used.

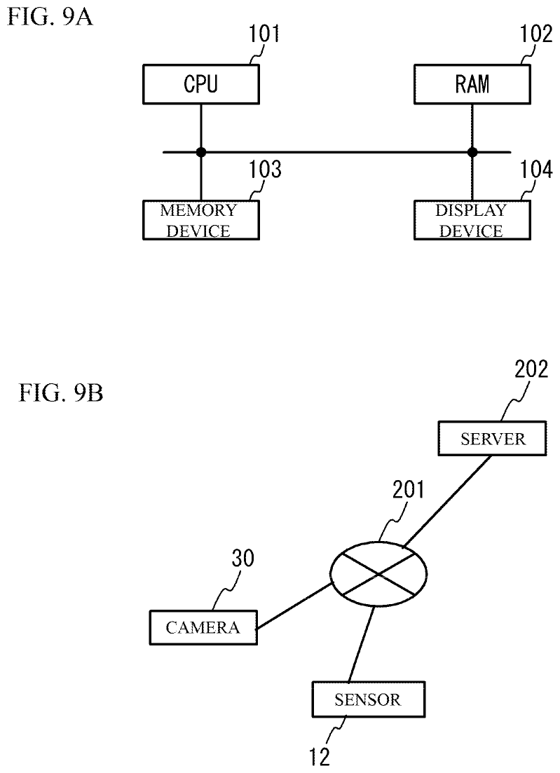

FIG. 9A illustrates a hardware structure of the learning device 40 and the determining device 50. As illustrated in FIG. 9A, the learning device 40 and the determining device 50 have a CPU (Central Processing Unit) 101, a RAM (Random Access Memory) 102, a memory device 103, a display device 104 and so on.

The CPU 101 includes one or more core. The RAM 102 is a volatile memory temporally storing a program executed by the CPU 101, a data processed by the CPU 101, and so on. The memory device 103 is a nonvolatile memory device. The memory device 103 may be a SSD (Solid State Drive) such as a ROM (Read Only Memory) or a flash memory, or a hard disk driven by a hard disk drive. The memory device 103 stores a learning program and a determining program. The display device 104 is such as a liquid crystal display or an electroluminescence panel and shows results of the learning process or the determining process. In the embodiment, each function of the learning device 40 and the determining device 50 is achieved by the execution of the programs. However, each function of the learning device 40 and the determining device 50 may be a hardware such as a dedicated circuit.

### Modified Embodiment

FIG. 9B illustrates a work system of a modified embodiment. In the above-mentioned embodiments, the learning device 40 and the determining device 50 obtain the sensor data from the sensor 12 and capture an image from the camera 30. Instead of the structure, a server 202 having the function of the learning device 40 and the determining device 50 may receive the sensor data from the sensor 12 via an electrical communication line 201 such as Internet and may capture the image from the camera 30 via the electrical communication line 201.

In the above-mentioned embodiments, the probability distribution generator 42 acts as a probability distribution generator for generating a probability distribution with respect to each of devices, from sensor data for learning obtained from a sensor provided in each of the devices. The similarity calculator 43 acts as a similarity calculator for calculating a difference degree among each group of the probability distributions. The mixed model generator 44 acts as a probability model generator for generating a probability model by synthesizing a group of which the difference degree is less than a threshold into a single probability distribution, multiplying each coefficient with each of the probability distributions, and adding resulting probability distributions to each other. The abnormality degree setter 45 and the threshold setter 46 act as a standard generator for generating a standard for abnormality determination from the probability model. The determiner 53 acts as a determiner for determining whether abnormality occurs in sensor data for determining obtained from a sensor provided in a device, on a basis of a relationship between the standard for abnormality determination and the sensor data for determining.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An apparatus comprising:
a memory; and
a processor coupled to the memory and the processor configured to execute a process, the process comprising:
generating a probability distribution with respect to each of devices, from first sensor data for learning obtained from a sensor provided in each of the devices;
calculating a difference degree among each group of the probability distributions;
generating a probability model by synthesizing a group of which the difference degree is less than a threshold into a single probability distribution, multiplying each coefficient with each of the probability distributions, and adding resulting probability distributions to each other; and
generating a standard for abnormality determination from the probability model.

2. The apparatus as claimed in claim 1, wherein the difference degree is a KL divergence.

3. The apparatus as claimed in claim 1, wherein, in the generating of the probability model, an observation model of the difference degree is assumed, a distribution of the difference degree is predicted with use of Bayesian approach, and a statistic amount of the distribution is used as the threshold.

4. The apparatus as claimed in claim 1, wherein the coefficient is a cluster assignment probability of each of clusters, when the probability distribution with respect to each of the devices is treated as a cluster.

5. The apparatus as claimed in claim 1, wherein the device is further configured to:
determine whether abnormality occurs in second sensor data for determining obtained from the sensor, on a basis of a relationship between the standard for abnormality determination generated by the device and the second sensor data for determining.

6. The apparatus as claimed in claim 5, wherein the difference degree is a KL divergence.

7. The apparatus as claimed in claim 5, wherein, in the generating of the probability model, an observation model of the difference degree is assumed, a distribution of the difference degree is predicted with use of Bayesian approach, and a statistic amount of the distribution is used as the threshold.

8. The apparatus as claimed in claim 5, wherein the coefficient is a cluster assignment probability of each of clusters, when the probability distribution with respect to each of the devices is treated as a cluster.

9. A method comprising:
generating a probability distribution with respect to each of devices, from first sensor data for learning obtained from a sensor provided in each of the devices;
calculating a difference degree among each group of the probability distributions;
generating a probability model by synthesizing a group of which the difference degree is less than a threshold into a single probability distribution, multiplying each coefficient with each of the probability distributions, and adding resulting probability distributions to each other; and
generating a standard for abnormality determination from the probability model.

10. The method as claimed in claim 9, wherein the difference degree is a KL divergence.

11. The method as claimed in claim 9, wherein, in the generating of the probability model, an observation model of the difference degree is assumed, a distribution of the difference degree is predicted with use of Bayesian approach, and a statistic amount of the distribution is used as the threshold.

12. The method as claimed in claim 9, wherein the coefficient is a cluster assignment probability of each of clusters, when the probability distribution with respect to each of the devices is treated as a cluster.

13. The method as claimed in claim 9, further comprising:
determining whether abnormality occurs in second sensor data for determining obtained from the sensor, on a basis of a relationship between the standard for abnormality determination generated by the learning method and the second sensor data for determining.

14. The method as claimed in claim 13, wherein the difference degree is a KL divergence.

15. The method as claimed in claim 13, wherein, in the generating of the probability model, an observation model of the difference degree is assumed, a distribution of the difference degree is predicted with use of Bayesian approach, and a statistic amount of the distribution is used as the threshold.

16. The method as claimed in claim 13, wherein the coefficient is a cluster assignment probability of each of clusters, when the probability distribution with respect to each of the devices is treated as a cluster.

17. A computer-readable, non-transitory medium storing a program that causes a computer to execute a process, the process comprising:
generating a probability distribution with respect to each of devices, from sensor data for learning obtained from a first sensor provided in each of the devices;
calculating a difference degree among each group of the probability distributions;
generating a probability model by synthesizing a group of which the difference degree is less than a threshold into a single probability distribution, multiplying each coefficient with each of the probability distributions, and adding resulting probability distributions to each other; and
generating a standard for abnormality determination from the probability model.

18. The medium as claimed in claim 17, wherein the difference degree is a KL divergence.

19. The medium as claimed in claim 17, wherein, in the generating of the probability model, an observation model of the difference degree is assumed, a distribution of the difference degree is predicted with use of Bayesian approach, and a statistic amount of the distribution is used as the threshold.

20. The medium as claimed in claim 17, wherein the process further comprising:
determining whether abnormality occurs in second sensor data for determining, on a basis of a relationship between the standard for abnormality determination generated and the second sensor data for determining obtained from the sensor.
